(19) United States
(12) Patent Application Publication
(10) Pub. No.: US 2012/0083038 A1
(43) Pub. Date: Apr. 5, 2012

(54) Methods for Detecting the Presence or Absence of Blood

(76) Inventors: Martin Jan Peter Eversdijk, LE Nieuw Vennep (NL); Marinus Johannes Floribert Gelderman, Amstelveen (NL)

(21) Appl. No.: 13/376,692

(22) PCT Filed: Jun. 16, 2009
(86) PCT No.: PCT/EP09/57469

§ 371 Date: Dec. 7, 2011

(51) Int. Cl. G01N 21/76

(52) U.S. Cl. 436/94; 436/172

(57) ABSTRACT

The present invention relates to methods for detecting presence, or absence, of blood. Specifically, the present invention relates to methods for detecting the presence, or absence, of blood, comprising applying a solution comprising luminol, or luminol derivative, a base, an oxidizing agent and fluorescein, or a fluorescein derivative, on a surface to be investigated for the presence of blood and detecting the presence, or absence, of blood depending on spectral response Further, the present invention relates to chemical compositions for detecting presence, or absence, of blood. Furthermore, the present invention relates to a kit for detecting presence, or absence, of blood comprising the chemical composition.

The present invention relates to methods for detecting presence, or absence, of blood. Further, the present invention relates to chemical compositions for detecting presence, or absence, of blood. Furthermore, the present invention relates to a kit for detecting presence, or absence, of blood comprising the chemical composition.

Chemiluminescence is a sensitive and selective spectroscopic technique. The beneficial effect of chemiluminescence resides in that it does not need an excitation source and does not require specific or complex optics to be detected. Most chemiluminescent reactions involve a few components to generate light: a chemiluminescent compound (the actual light generator) and a chemical oxidizer. Examples of chemiluminescent compounds are peroxyoxalates, of which bis(2,4,6-trichlorophenyl)oxalate (TCPO) is an example used in chromatography techniques. The reactions mainly have to be carried out in organic solvents.

Luminol, another example of chemiluminescent compound, shows on the other hand, chemiluminescence in aqueous medium. Luminol is another chemiluminescent reagent exhibiting a blue glow when mixed with and appropriate oxidizing agent. Luminol is used in forensic Science for detecting the presence of blood.

Luminol chemiluminescence is reported, for example, by EP 1 497 664 relating to a composition for the detection of traces of blood. The luminol composition sprayed on a surface and produces a chemiluminescent response when blood is present.

There are continuous needs in the prior art to further develop blood detection methods.

It is a goal of the present invention, amongst others, to provide a more efficient method for detecting the presence, or absence, of blood in comparison with the conventional methods using luminol.

According to the present invention, this goal, amongst others, is met by the methods for detecting the presence, or absence, of blood by firstly applying a solution comprising luminol, or luminol derivative, a base, an oxidizing agent and fluorescein, or a fluorescein derivative, on a surface to be investigated for the presence of blood and successively detecting the presence, or absence, of blood depending on spectral response. The intensity of the detection response, or signal, is maximum for a longer period of time than conventional detection methods using luminol, even at low chemiluminescent agent concentrations. The methods of the present invention are applicable on any type of surface to be investigated. The detection is visible by naked eye. The solution can, for example, be in deionized water, milli-Q water, demineralized water, water with alcoholic content of methanol, ethanol, isopropanol or saline solutions containing a buffer, chelate agents or any inert salts, such as NaCl or KCl. An inert salt does neither react with luminol, nor fluorescein.

A base is any chemical compound which has an alkaline or basic activity in water, accepting hydrogen ions (H⁺) and therefore increasing the pH.

An oxidizing agent is any chemical compound able to be reduced, give one, or more, electrons to a substance to be oxidized.

The surface to be investigated is part of a suspected crime scene, an accident or any other situations, where the presence, or absence, of blood requires being detected, or analyzed.

When blood, blood stains, or blood traces are present, an intense spectral response, or light emission, appears on the surface where a solution comprising luminol, or luminol derivative, a base, an oxidizing agent and fluorescein, or a fluorescein derivative, is applied. The response is visible by naked eye. Said response is a combination of chemiluminescence and fluorescence. If no blood is present, applying the solution on a surface shows no spectral response.

In a preferred embodiment of the present invention, the methods for detecting the presence, or absence, of blood applying the solution comprises spraying the solution.

According to the invention, the methods for detecting the presence, or absence, of blood comprise luminol, or luminol derivative, in the range of 0.01 mmol to 15 mmol per liter of aqueous solution, such as such as 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 7, 8, 9, 10, 11, 12, 13, 14, or 15 mmol per liter.

According to the present invention, the methods detecting the presence, or absence, of blood comprise a solution with an alkaline pH. Alkaline pH is a pH above 7 or in the range of 7.1 to 14, such as 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, or 14.0.

According to the present invention, the methods detecting the presence, or absence, of blood comprise an oxidizing agent in the range of 1 to 150 mmol per liter of solution, such as 1, 2, 3, 4, 5, 6, 7, 8, 9, 10, 15, 20, 25, 30, 35, 40, 45, 50, 55, 60, 65, 70, 75, 80, 85, 90, 100, 110, 120, 130, 140, 150 mmol per liter.

According the present invention, the methods detecting the presence, or absence, of blood comprise fluorescein, or fluorescein derivative, in the range of 0.05 to 7 mmol per liter of solution, such as 0.05, 0.1, 0.15, 0.2, 0.25, 0.3. 0.35, 0.04, 0.045, 0.05, 0.055, 0.06, 0.065, 0.07, 0.075, 0.08, 0.085, 0.09, 0.095, 0.1, 0.15, 0.2, 0.25, 0.3, 0.35, 0.4, 0.45, 0.5, 0.55, 0.6, 0.65, 0.7, 0.75, 0.8, 0.85, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10 mmol per liter.

According to another preferred embodiment of the present invention, the methods for detecting the presence, or absence, of blood comprise a luminol derivative wherein the luminol derivative is an alkyl or aryl substituted luminol, amine-, thiol-, carboxy-, carbalkoxy-, aldo-, keto-, hydroxy- or halogen-substituted luminol. Alkyl or aryl substituents are substituents of hydrocarbons of any lengths, non-aromatic or aromatic respectively. Said substituents are substituted or unsubstituted. Amine-corresponds to the —NH₂ functional group (comprising secondary and tertiary amines), thiol- corresponds to the —SH group, carboxy- to the carboxylic acid group —COOH, carbalkoxy- to the ester group —COO—, aldo- to the aldehyde group —CHO, keto- to the ketone group —CO—, hydroxy- to the alcohol group —OH and halogen- is —F, —Cl, —Br, —I, —At. When allowable, each functional group mentioned herewith can be substituted or unsubstituted by hydrocarbon substituents.

According to the present invention, the methods detecting the presence, or absence, of blood comprise luminol, or luminol derivative, in the range of 0.01 to 15, preferably 0.05 to 12, more preferably 0.1 to 10, most preferably 0.2 to 8 mmol per liter of solution.

In another preferred embodiment of the present invention, the methods for detecting the presence, or absence, of blood comprise a solution with a pH in the range of 7.1 to 13, preferably 8 to 13, more preferably 9 to 13.

In another preferred embodiment of the present invention, the methods for detecting the presence, or absence, of blood comprise a solution wherein the base is a metallic hydroxide.

In yet another preferred embodiment of the present invention, the methods for detecting the presence, or absence, of blood comprise a solution wherein the base is sodium hydroxide or potassium hydroxide.

According to the present invention, the methods for detecting the presence, or absence, of blood comprise an oxidizing agent in the range 1 to 150, preferably 2 to 90, more preferably 2 to 15 mmol per liter of solution.

In one preferred embodiment of the present invention, the methods for detecting the presence, or absence, of blood comprise an oxidizing agent wherein the oxidizing agent is a peroxide compound.

In a more preferred embodiment of the present invention, the methods for detecting the presence, or absence, of blood comprise an oxidizing agent wherein the oxidizing agent is hydrogen peroxide.

In another preferred embodiment of the present invention, the methods for detecting the presence, or absence, of blood comprise an oxidizing agent wherein the oxidizing agent is a metallic perchlorate, such as sodium perchlorate or potassium perchlorate, or a metallic permanganate, such as potassium perchlorate.

According to the present invention, the methods for detecting the presence, or absence, of blood comprise fluorescein, or fluorescein derivatives wherein the fluorescein derivative is fluorescein, alkyl or aryl substituted fluorescein, amine-, thiol-, thiocyanate-, carboxy-, carbalkoxy, aldo-, keto-, hydroxy- or halogen-substituted fluorescein.

Alkyl or aryl substituents are hydrocarbon substituents of any lengths, non-aromatic or aromatic respectively. Said substituents are substituted or unsubstituted. Amine-corresponds to the —NH₂ functional group (comprising secondary and tertiary amines), thiol- corresponds to the —SH group, thiocyanate is a functional group —NCS— or —SCN—, carboxy- corresponds to the carboxylic acid functional group —COOH, carbalkoxy- to the ester group —COO—, aldo- to the aldehyde group —CHO, keto- to the ketone group —CO—, hydroxy- to the alcohol group -OH and halogen- is —F, —Cl, —Br, —I, —At. When allowable, each functional group mentioned herewith can be substituted or unsubstituted by hydrocarbon substituents.

According to the present invention, the methods for detecting the presence, or absence, of blood comprise fluorescein derivative chosen from the fluorescein derivatives eosin Y, phloxin B or erythrosine B.

According to the present invention, the methods for detecting the presence, or absence, of blood comprise a fluorescein, or fluorescein derivative, in the range of 0.05 to 10, preferably 0.1 to 7 mmol per liter of aqueous solution.

In another aspect, the present invention relates to a chemical composition comprising a solution of luminol, or luminol derivative, a base, an oxidizing agent and fluorescein, or a fluorescein derivative.

In another aspect, the present invention relates to a kit for detecting the presence, or absence, of blood comprising one of more containers comprising luminol, a base, an oxidizing agent and/or fluorescein ingredients, means for applying a solution on a surface be investigated, instructions for use of the kit in detecting blood presence. A kit is a packaging of different components in order to provide a ready-to-use set of items.

In yet another aspect, the present invention relates to a use of the chemical composition for blood detection.

In still another aspect, the present invention relates to a use of chemical composition for DNA detection.

### FIGURE

The present invention will be further detailed in the following examples of preferred embodiments of the invention. In the examples, reference is made to the appended figure wherein:

FIG. 1: describes the spectral response of solution E with fluorescein(Luminol 0.4 mmol/l, NaOH 45 mmol/l, H₂O₂ 17.6 mmol/1) .

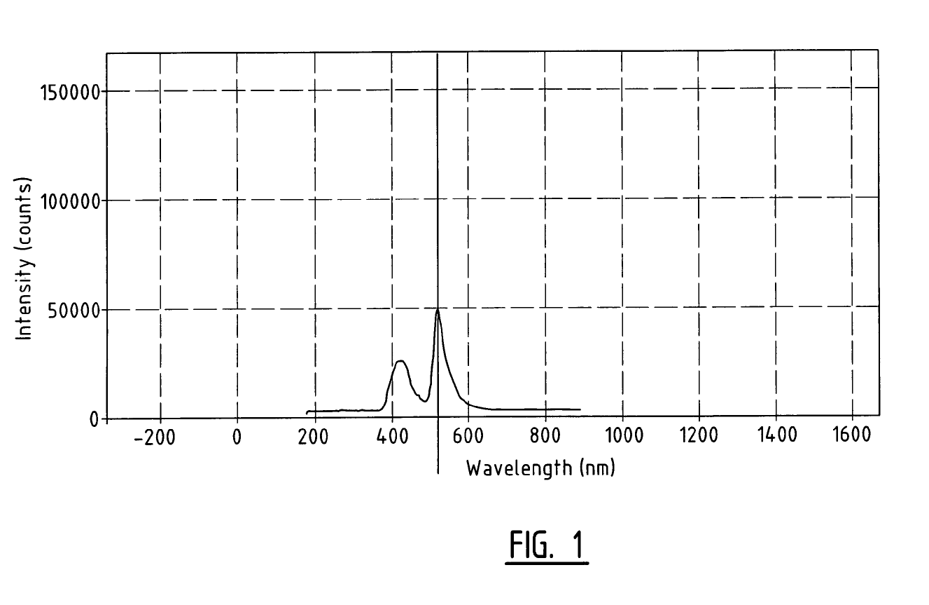

The herewith data were collected at 20° C. with multimode optical fiber and with an Ocean Optics spectrophotometer USB4000.

### Examples

Experimental spectral response collection has been performed for 5 different Examples: each example compares the spectral response of the blood detection in a solution containing luminol, NaOH and H₂O₂ without fluorescein, called reference solution, with a solution containing the same amount of luminol and NaOH, but a different quantity of H₂O₂ and containing fluorescein with a concentration of 6 mmol per liter of fluorescein. The reference solution has a total concentration of H₂O₂ up to 4 times higher than the solution containing fluorescein.

An increased spectral response is observed when fluorescein is present with luminol, compared to the equivalent reference solution. This effect is observed with any concentration of luminol or fluorescein, even with low concentration of luminol and/or fluorescein.

TABLE 1
Comparison of the spectral response of samples containing blood in solution comprising
luminol, NaOH and H₂O₂, without (reference) and with fluorescein.
The spectral response is higher when fluorescein is present.

| | Reference | | | | | | Relative |
|---|---|---|---|---|---|---|---|
| | solution | | Relative | | | Relative | Intensity |
| | without | | Intensity | Solution with | | Intensity | Increase |
| Examples | fluorescein | | (counts) | fluorescein | | (counts) | (%) |
| 1 | Luminol | 5 mmol/l | 55282 | Luminol | 5 mmol/l | 63995 | 16 |
| | NaOH | 50 mmol/l | | NaOH | 50 mmol/l | | |
| | H₂O₂ | 50 mmol/l | | H₂O₂ | 12.8 mmol/l | | |
| 2 | Luminol | 5 mmol/l | 57787 | Luminol | 5 mmol/l | 65535 | 13 |
| | NaOH | 90 mmol/l | | NaOH | 90 mmol/l | | |
| | H₂O₂ | 50 mmol/l | | H₂O₂ | 12.8 mmol/l | | |
| 3 | Luminol | 5 mmol/l | 14921 | Luminol | 5 mmol/l | 26876 | 80 |
| | NaOH | 25 mmol/l | | NaOH | 25 mmol/l | | |
| | H₂O₂ | 50 mmol/l | | H₂O₂ | 12.8 mmol/l | | |
| 4 | Luminol | 5 mmol/l | 34577 | Luminol | 5 mmol/l | 42136 | 22 |
| | NaOH | 40 mmol/l | | NaOH | 40 mmol/l | | |
| | H₂O₂ | 50 mmol/l | | H₂O₂ | 12.8 mmol/l | | |
| 5 | Luminol | 0.4 mmol/l | 30384 | Luminol | 0.4 mmol/l | 48669 | 60 |
| | NaOH | 45 mmol/l | | NaOH | 45 mmol/l | | |
| | H₂O₂ | 17.6 mmol/l | | H₂O₂ | 4.5 mmol/l | | |

### Example 1

The intensity of the reference solution detects blood with a response of 55282 units. In presence of fluorescein, the blood is detected with a response of 63995 units, corresponding to a response 16% higher in intensity. Thus, the spectral response in presence of fluorescein is significantly higher when the solution contains fluorescein. The quantity of H₂O₂ has been lowered 4 times and therefore causes less damage to the surface or blood sample.

### Example 2

The intensity of the reference solution detects blood with a response of 57786 units. In presence of fluorescein, the blood is detected with a response of 65535 units, corresponding to a response 13% higher in intensity. Thus, the spectral response in presence of fluorescein is significantly higher when the solution contains fluorescein. The quantity of H₂O₂ has been lowered 4 times and therefore causes less damage to the surface or blood sample.

### Example 3

The intensity of the reference solution detects blood with a response of 14922 units. In presence of fluorescein, the blood is detected with a response of 26876 units, corresponding to a response 80% higher in intensity. Thus, the spectral response in presence of fluorescein is oustandingtly higher when the solution contains fluorescein. The quantity of H₂O₂ has been lowered 4 times and therefore causes less damage to the surface or blood sample.

### Example 4

The intensity of the reference solution detects blood with a response of 34577 units. In presence of fluorescein, the blood is detected with a response of 42136 units, corresponding to a response 22% higher in intensity. Thus, the spectral response in presence of fluorescein is significantly higher when the solution contains fluorescein. The quantity of H₂O₂ has been lowered to 4 times and therefore causes less damage to the surface or blood sample.

### Example 5

The intensity of the reference solution detects blood with a response of 30384 units. In presence of fluorescein, the blood is detected with a response of 48669 units, corresponding to a response 60% higher in intensity. Thus, the spectral response in presence of fluorescein is outstandingly higher when the solution contains fluorescein. The quantity of H₂O₂ has been lowered to 4 times and therefore causes less damage to the surface or blood sample.

1. Method for detecting the presence, or absence, of blood, comprising:
a) applying a solution comprising luminol, or luminol derivative, a base, an oxidizing agent and xanthenes dyes such as fluorescein, or a fluorescein derivative, on a surface to be investigated for the presence of blood;
b) detecting the presence, or absence, of blood depending on spectral response.

2. Method for detecting the presence, or absence, of blood according to claim 1, wherein applying the solution comprises spraying the solution.

3. Method for detecting the presence, or absence, of blood according to claim 1, wherein the luminol, or luminol derivative, is in the range 0.01 mmol to 15 mmol per liter of solution, wherein the pH of the solution is alkaline, wherein the oxidizing agent is in the range 1 to 150 mmol per liter of solution and Wherein the fluorescein, or fluorescein derivative, is in the range of 0.05 to 10 mmol per liter of solution.

4. Method for detecting the presence, or absence, of blood according to claim 1, wherein the luminol derivative is alkyl or aryl substituted luminol, amine-, thiol-, carboxy-, carbalkoxy-, aldo-, keto-, hydroxy- or halogen-substituted luminol.

5. Method for detecting the presence, or absence, of blood according to claim 1, wherein the luminol derivative is in the range of 0.01 to 15, preferably 0.05 to 12, more preferably 0.1 to 8, most preferably 0.2 to 8 mmol per liter of solution.

6. Method for detecting the presence, or absence, of blood according to claim 1, wherein the solution has a pH in the range of 7.1 to 13.

7. Method for detecting the presence, or absence, of blood according to claim 1, wherein the base is a metallic hydroxide.

8. Method for detecting the presence, or absence, of blood according to claim 1, wherein the base is sodium hydroxide or potassium hydroxide.

9. Method for detecting the presence, or absence, of blood according to claim 1, wherein the oxidizing agent is in the range 1 to 150 mmol per liter of solution.

10. Method for detecting the presence, or absence, of blood according to claim 1, wherein the oxidizing agent is a peroxide compound.

11. Method for detecting the presence, or absence, of blood according to claim 1, wherein the oxidizing agent is a hydrogen peroxide.

12. Method for detecting the presence, or absence, of blood according to claim 1, wherein the oxidizing agent is metallic perchlorate or metallic permanganate.

13. Method for detecting the presence, or absence, of blood according to claim 1, wherein the fluorescein derivative is fluorescein, alkyl or aryl substituted fluorescein, amine-, thiol-, thiocyanate-, carboxy-, carbalkoxy-, aldo-, keto-, hydroxy-, or halogen-substituted fluorescein.

14. Method for detecting the presence, or absence, of blood according to claim 1, wherein the fluorescein derivative is chosen from the fluorescein derivatives eosin Y, phloxin B or erythrosine B.

15. Method for detecting the presence, or absence, of blood according to claim 1, wherein the fluorescein derivative is in the range of 0.05 to 10 mmol per liter of solution.

16. Chemical composition for detecting the presence, or absence, of blood comprising a solution as defined in claim 1.

17. Kit for detecting the presence, or absence, of blood comprising:
a) one of more containers comprising luminol, a base, an oxidizing agent and/or fluorescein ingredients as defined in claim 1;
b) means for applying a solution on a surface be investigated;
c) instructions for use of the kit in detecting blood presence.

18. (canceled)

19. (canceled)

20. A method of detecting DNA comprising:
a) applying to a surface a solution comprising 0.05 to 10 mmol per liter solution of a fluorescein derivative; and
b) detecting the presence of DNA depending on spectral response.
